(19) United States
(12) Patent Application Publication
(10) Pub. No.: US 2007/0200951 A1
(43) Pub. Date: Aug. 30, 2007

(54) IMAGE PROCESSING METHOD AND DEVICE

(75) Inventors: Shian-Sung Shiu, Taipei (TW); Chen-Chien Chung, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BEYOND INNOVATION TECHNOLOGY CO., LTD., Taipei (TW)

(21) Appl. No.: 11/530,050

(22) Filed: Sep. 8, 2006

(30) Foreign Application Priority Data
Feb. 24, 2006 (TW) 95106704

(51) Int. Cl. H04N 5/04; H04N 3/26

(52) U.S. Cl. 348/500; 348/806; 345/213

(57) ABSTRACT

The invention provides an image processing method and device to determine whether the timing signal is abnormal by detecting timing signal related to the image signal output to the display. When the timing signal is abnormal, the display receives no the timing signal related to the image signal. The horizontal synchronous signal and vertical synchronous signal prevent the elements in the display, such as electron gun, from operating with abnormal signals, enhancing display lifetime.

### BACKGROUND OF THE INVENTION

1. Field of the Invention

The invention relates to an image processing method and an image processing device. In particular, the invention relates to an image processing method and an image processing device with a protecting mechanism that a display is able to receive image signals in the correct timing and that the display lifetime increases.

2. Description of the Related Art

A Cathode Ray Tube (CRT) display utilizes an electron gun, deflection coils, a shadow mask, a phosphor layer and a glass display. The electron gun is able to generate high energy electronic beams of 25000V. The shadow mask directs the electronic beams accurately to the phosphor layer on the glass display and phosphor spots thereof generate light spots. In the same time, by controlling the energy density of the electronic beam, the display is able to generate different colors and brightness. When the CRT display receives the image signal from a computer display card or television signal transmitter, the electron gun scans from the top left corner of the display, from left to right and from top to bottom. Repeating the above scanning process generates visible images.

Referring to FIG. 1, FIG. 1 shows a conventional CRT display 100. In the FIG. 1, electron gun 101 of CRT display 100 generates electronic beams 103. Shadow mask 105 directs electronic beams 103 to hit against the R, G and B phosphor spots 109 on glass display 107 which then emit light for a displayed image.

Referring to the FIG. 2, FIG. 2 shows a conventional CRT display receiving image signals from image processing terminals. After a digital image signal 201 is processed through digital signal processor 203 of image processing terminals 200 and D/A converters 204, 205 and 206 sequentially, analog image signals 214, 215 and 216 output to CRT display 202 respectively from D/A converters 204, 205 and 206.

In the above process, the clock signal 210 of the digital signal processor 203 and the clock signal 208 of D/A converter 204-206 is generated by clock generator 207 of image processing terminals 200. Clock generator 207 receives clock signal 212 and synchronous signal 213 and outputs clock signal 208 to D/A converters 204, 205, and 206, clock signal 210 to Digital signal processor 203, horizontal synchronous signal (HSYNC) 209 and vertical synchronous signal (VSYNC) 211 to CRT display 202 for synchronization.

When synchronous signal 213 or clock signal 212 are abnormal, the logic levels of horizontal synchronous signal 209 and vertical synchronous signal 211 are always high or the frequency of synchronous signal 209 and vertical synchronous signal 211 is unstable, and they may cause electron gun 101 to generate electronic beams 103 during horizontal blanking interval (HBI) or vertical blanking interval (VBI). This reduces the lifetime of electron gun 101 and phosphor 109. In short, when synchronous signal 213 or clock signal 212 are abnormal, the lifetime of CRT display 100 will possibly decrease.

In addition, when synchronous signal 213 or clock signal 212 are abnormal, clock generator 207 outputs abnormal clock signals 208 to D/A converters 204, 205 and 206. Because of the abnormal clock signals 208, D/A converters 204, 205, 206 will output signal 214, 215 and 216 at wrong timing. Therefore, CRT display 100 will also generate unexpected images.

According to the above problem, this invention provides an image processing method and an image processing device that the display receives image at correct timing to protect the display and increases the lifetime of the display.

### BRIEF SUMMARY OF THE INVENTION

The main purpose of the invention is to avoid that when synchronous signal or clock signal are abnormal, the display still operates. Using CRT display as an example, when synchronous signal or clock signal are abnormal, the lifetime of CRT display decreases. To achieve the described purpose, the invention provides an image processing protecting method comprising detecting a timing signal associated with a digital image signal, determining whether the timing signal is abnormal and when the timing signal is abnormal, a synchronous signal which the display receives and being associated with the image signal is set logic level 0. The above timing signal is a clock signal or the synchronous signal of the digital image. The timing signal or the synchronous signal of the digital image is provided by a digital image source terminal.

In an embodiment of the invention, the above method further includes detecting a first condition in which the clock signal holds at high level for long time and detecting a second condition in which the clock signal holds at low level for long time. The above method further comprises identifying the clock signal as an abnormal signal when the clock signal holds at high level for long time or the clock signal holds at low level for long time. The invention is able to directly detect whether the synchronous signal is abnormal.

In addition, the above method further includes not only that the synchronous signal which the display receives and being associated with the image signal is set logic level 0 but also an analog image signal which the display receives is set the lowest level. The above method further includes relieving the above limitation of the synchronous signal and the analog signal, when the timing signal is normal.

Similarly, for solving the above problem, the invention provides an image processing device. The image processing device comprises a clock state detecting device and an output state control device. The clock state detecting device detects a timing signal associated with an image signal and outputs a first detecting result signal. The output state control device receives a synchronous signal associated with the image signal, determines whether the timing signal is abnormal according to the first detecting result signal and then determines to output the synchronous signal to the display or not.

In an embodiment of the invention, the image processing device further includes a digital signal processor, a clock generator, and D/A converters (not necessary). The digital signal processor receives and processes the image signal and then outputs digital image signals. The D/A converters receive the digital image signals from the digital signal processor. The D/A converters convert the digital image signals into analog image signals and output the analog image signals to the display. The clock generator receives an external clock signal or a image synchronous signal and generates a clock signal and a synchronous signal for each other unit.

In an embodiment of the invention, the image processing device further includes a long time and low level clock detecting device, a long time and high level clock detecting device, and a clock state determining device. The long time and low level clock detecting device detects the clock signal. If the clock signal holds at low level for long time, the long time and low level clock detecting device outputs a second detecting result signal. The long time and high level clock detecting device detects the clock signal. If the clock signal holds at high level for long time, the long time and high level clock detecting device outputs a third detecting result signal. The clock state determining device determines to output the first detecting result signal according to the second detecting result signal and the third detecting result signal.

### BRIEF DESCRIPTION OF THE DRAWINGS

The invention can be more fully understood by reading the subsequent detailed description and examples with references made to the accompanying drawings, wherein:

FIG. 1 shows a conventional CRT display.

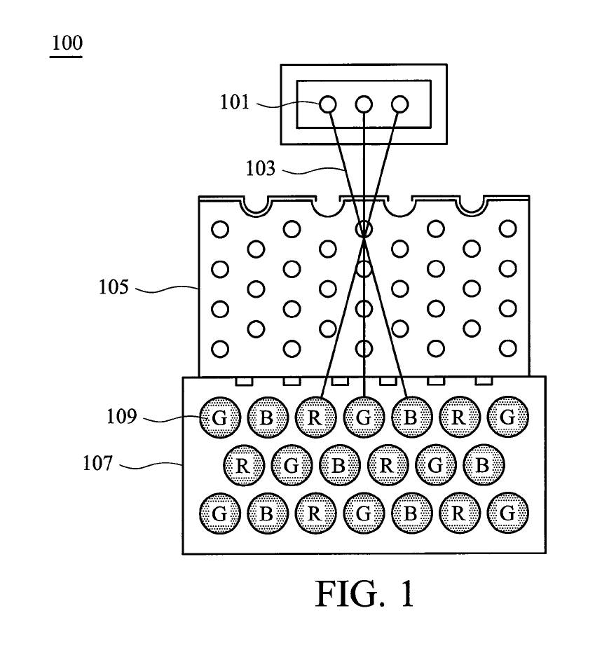

FIG. 2 shows a conventional CRT display receiving an output image signals from image processing terminals.

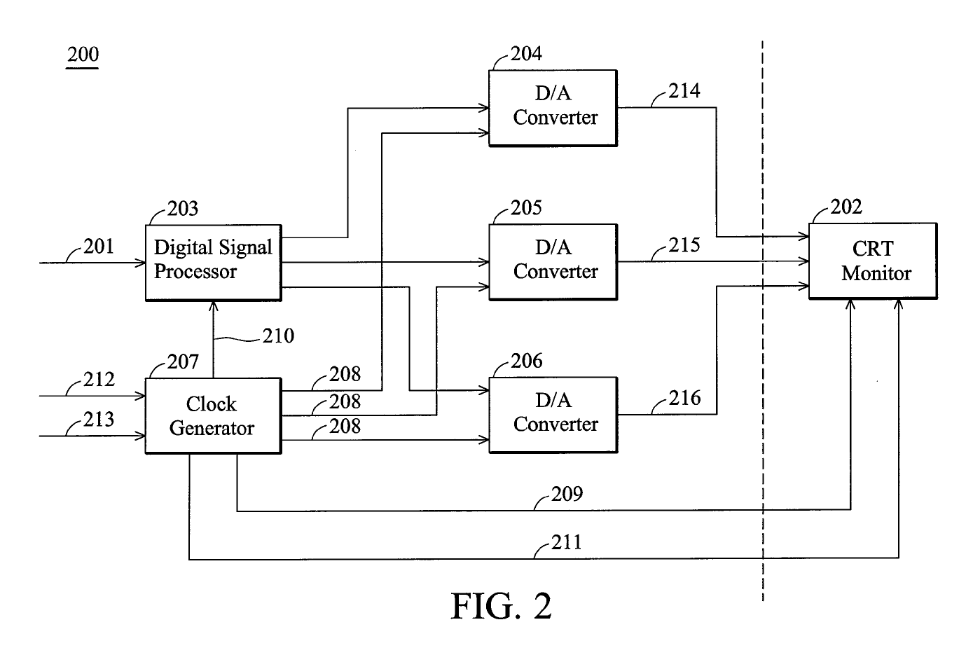

FIG. 3 is flowchart illustrating a method for image processing of an embodiment of the invention.

FIG. 4 shows an image processing device of an embodiment of the invention.

FIG. 5 shows detailed circuitry of a clock state detecting device of FIG. 4 of an embodiment of the invention.

FIG. 6 is a normal time order diagram of each node of the circuit in FIG. 5.

FIG. 7 shows detailed circuitry of an output state control device of an embodiment of the invention.

### DETAILED DESCRIPTION OF THE INVENTION

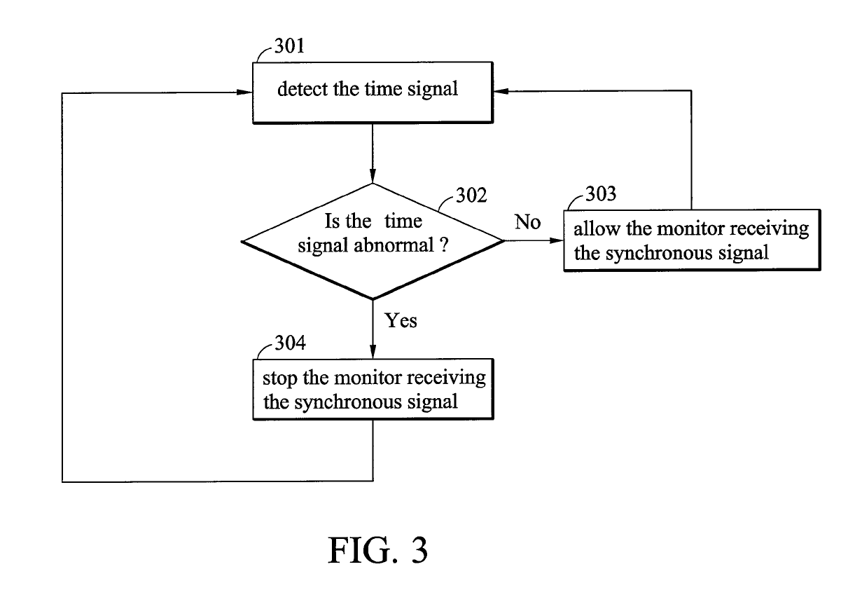

Please refer to FIG. 3; FIG. 3 is a flowchart illustrating a method for image processing consistent with an embodiment of the invention. First, in step 301, the timing signal is detected. The timing signal inputted to a display is associated with an image signal. The timing signal can be a clock signal from an image processing terminal or a synchronous signal with image signal.

Second, in step 302, it is determined whether the timing signal is abnormal. For example, the timing signal is a clock signal, and the timing signal is checked by detecting whether the clock signal is logic high for a long time or logic low for a long time.

If the timing signal is normal, in step 303, the display receives horizontal synchronous signal (HSYNC) and vertical synchronous signal (VSYNC) corresponding to image signal. If the timing signal is abnormal, in step 304, the display is asked to not receive the synchronous signals and the synchronous signals are set logic level 0.

After steps 303 and 304, user can set a timing period to repeat step 301. The repeat detecting of the timing signal allows the display to show images in correct timing. According to the invention, with a CRT display as an example, when the horizontal synchronous signal and vertical synchronous signal accompanied with image signal are normal, the electron gun is allowed to receive the horizontal synchronous signal and vertical synchronous signal accompanied with image signal. The electron gun does not emit electronic beams when the horizontal synchronous signal and vertical synchronous signal are abnormal for increasing the lifetime of the CRT display.

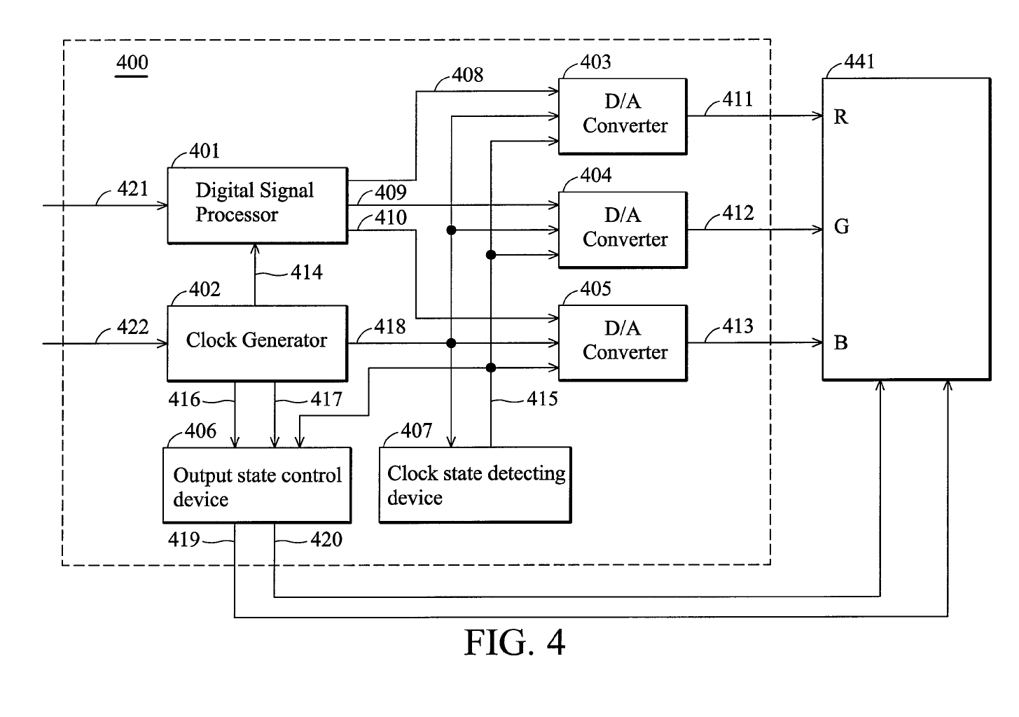

Please refer to FIG. 4; FIG. 4 shows an image processing device of an embodiment of the invention. Image processing device 400 comprises digital signal processor 401, clock generator 402, D/A converters 403, 404 and 405, clock state detecting device 407 and output state control device 406. Clock state detecting device 407 and output state control device 406 are able to protect display monitor 441.

In FIG. 4, image processing device 400 with protecting devices processes digital image signal 421 and then outputs to display monitor 441. Digital image signal 421 is separated by digital signal processor 401 into digital image signals 408, 409 and 410 associated with R, G and B information signal respectively. Digital image signals 408, 409 and 410 are respectively processed by D/A converters 403, 404 and 405 and then D/A converters 403, 404 and 405 output analog image signals 411, 412 and 413 to display monitor 441 respectively.

The working periods of respectively receiving analog image signals 411, 412 and 413 by D/A converters 403, 404 and 405 and image signals 408, 409 and 410 by digital signal processor 401 are controlled by clock generator 402 in image processing device 400. Clock generator 402 receives synchronous signal 422 accompanied with digital image signal 421 and provides clock signal 414 for the digital signal processor 401, clock signal 418 for D/A converters 403, 404 and 405, and first synchronous signal 416 and second, synchronous signal 417 for output state control device 416.

Clock state detecting device 407 detects whether clock signal 418 is abnormal and then outputs detecting result signal 415. Clock state detecting device 407 also directly detects synchronous signal 422 or any clock signal from clock generator 402. In an embodiment, clock state detecting device 407 detects clock signal 418 transmitted to D/A converters 403, 404 and 405 and outputs detecting result signal 415 to output state control device 406 and D/A converters 403, 404 and 405. According to detecting result signal 415, output state control device 406 controls the states of the first synchronous signal 416 and second synchronous signal 417 transmitted to display monitor 441 and D/A converters 403, 404 and 405 control the states of analog image signals 411,412 and 413 transmitted to display monitor 441.

Thus, while image processing device 400 is processing digital image signal 421, image processing device 400 with display protective function is able to detect synchronous signal 422 corresponding to digital image signal 421 or any clock signal from clock generator 402 (including clock signals 414 and 418, first synchronous signal 416 and second synchronous signal 417). According to the above detecting, image processing device 400 controls the states of horizontal synchronous signal 419 and vertical synchronous signal 420 output to display monitor 441. It is able to avoid that display monitor 441 still operates when horizontal synchronous signal 419 and vertical synchronous signal 420 are abnormal. Thus, the lifetime of display monitor 441 increases.

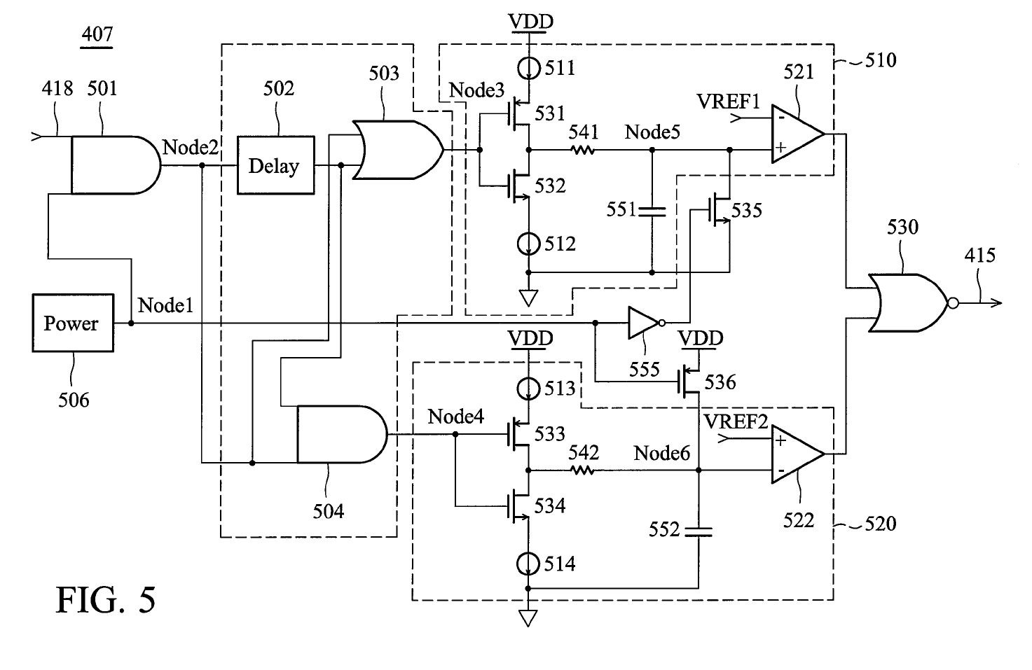

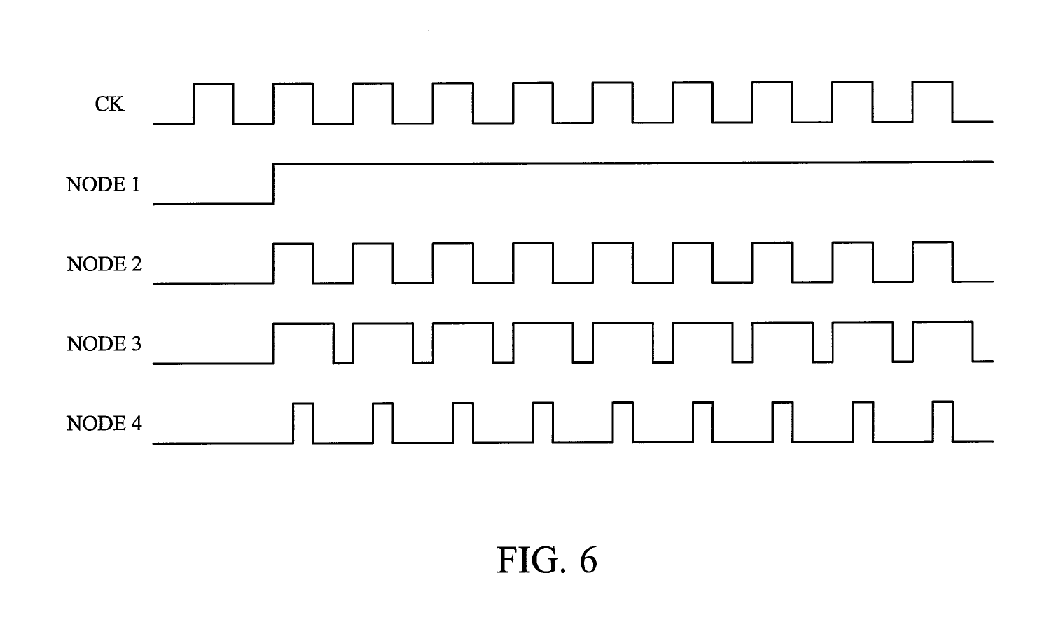

Please refer to FIG. 5 and FIG. 6 together; FIG. 5 shows detailed circuitry of a clock state detecting device of FIG. 4 of an embodiment of the invention. FIG. 6 is a normal timing diagram of each node of the circuit in FIG. 5. In FIG. 5, clock state detecting device 407 comprises long time and low level clock detecting device 510, long time and high level clock detecting device 520 and NOR gate 530 which is a clock state detecting device.

Long time and low level clock detecting device 510 comprises current sources 511 and 512, resistor 541, capacitor 551, comparator 521, PMOS 531 (P-type Metal Oxide Semiconductor), and NMOS 532 (N-type Metal Oxide Semiconductor). The current value of current source 512 exceeds that of current source 511.

Long time and high level clock detecting device 520 comprises current sources 513 and 514, resistor 542, capacitor 552, comparator 522, PMOS 533 and NMOS 534. The current of current source 513 exceeds that of current source 514. In an embodiment, each current value of current sources 512 and 513 are four times each current value of current sources 511 and 514.

In addition, clock state detecting device 407 further includes power starter (power on reset) 506, delay 502 and AND gates 501 and 504, OR gate 503, NMOS transistor 535, PMOS transistor 536 and inverter 555.

Each component of Clock detecting device 407 is described simply as following. After power starter 506 turning on, for a period, the voltage of Node I moves to logic high. During the period between power starter 506 turning on and the voltage of Node 1 changing to logic high, the voltage of Node 5 changes to logic low as NMOS transistor 535 (turn on) discharges current from Node 5 to the system lowest voltage level (VSS or ground). The voltage of Node 6 changes to logic high as PMOS transistor 536 (turn on) charges current to Node 6 to the system highest voltage level (VDD). After Node 1 changes to logic high, NMOS transistor 535 and PMOS transistor 536 turn off. After that, the voltage of Node 5 is the system lowest voltage level; the voltage of Node 6 is the system highest voltage level.

When clock signal 418 is normal, in one system period, the times of high voltage level much are far longer than the times of the low voltage level at Node 3. When the voltage at Node 3 is low, current source 511 through PMOS transistor 531 and resistor 541 charges capacitor 551. When the voltage at Node 3 is high, current source through NMOS transistor 532 and resistor 541 discharges capacitor 551. The times of high voltage level are far longer than the times of the low voltage level at Node 3 and the current value of current source 512 is bigger than the current value of current source 511. Thus, when clock signal 418 is normal, the voltage at Node 5 remains at the system lowest voltage level.

Comparator 521 compares the voltage at Node 5 with reference voltage VREF 1. When the voltage at Node 5 is lower than reference voltage VREF 1, comparator 521 outputs logic low signal.

In one system period, the times of low voltage level are much longer than the tomes of the high voltage level at Node 4. Thus, when clock signal 418 is normal, the voltage at Node 6 remains at the highest system voltage level (VDD). Comparator 522 compares the voltage at Node 6 with reference voltage VREF 2. When the voltage at Node 6 is lower than reference voltage VREF 2, comparator 522 outputs logic low signal. In an embodiment of invention, reference voltage VREF 2 and reference voltage VREF 1 are lower than the voltage of system power supply (VDD). For example, reference voltage VREF 1 is 2.5V and reference voltage VREF 2 is 1V. The voltage of power supply (VDD) is 3.3 volt. Thus, when clock signal 418 is normal, the output signals of comparators 522 and 523 are logic low level.

Therefore, detecting result signal 415 output by NOR gate 530 is logic high level.

When clock signal 418 is abnormal and the voltage level of clock signal 418 is pulled down to the system lowest voltage level, the voltage levels at Node 3 and Node 4 are logic low level. Thus, capacitor 551 is charged continuously by the current through PMOS transistor 531 and resistor 541 from current source 511 until the voltage at Node 5 reaches to the voltage of power supply (VDD) or clock signal is normal. During charging, after the voltage at Node 5 exceeds the reference voltage VREF 1, the voltage of the output signal of comparator 521 moves from the low voltage level to the high voltage level. Detecting result signal 415 output by NOR gate 530 moves from high voltage level to low voltage level. The above changing of detecting result signal 415 indicates that clock signal 418 is abnormal. After clock signal 418 becomes normal for some periods, the voltage at Node 5 moves to the system lowest voltage level (ground) and detecting result signal 415 moves from the low voltage level to the high voltage level again. Capacitor 552 is charged by the current through PMOS transistor 533 and resistor 542 from current source 513 at the same time. The voltage at Node 6 has been the voltage of power supply (VDD), thus the output state of comparator 522 does not change.

When clock signal 418 is abnormal and the voltage level of clock signal 418 remains to be pulled high to the system highest voltage level, the voltage levels at Node 3 and node 4 are logic high level. Thus, capacitor 552 is discharged by the current of current source 514 through NMOS transistor 534 and resistor 542 until the voltage at Node 6 reaches to the system lowest voltage level (ground) or clock signal 418 is normal. During discharging, when the voltage at Node 6 is smaller than the reference voltage VREF 2, the voltage of the output signal of comparator 522 moves from the low voltage level to the high voltage level. Detecting result signal 415 output by NOR gate 530 moves from high voltage level to low voltage level. The above changing of detecting result signal 415 indicates that clock signal 418 is abnormal. After clock signal 418 becomes normal for some periods, the voltage at Node 6 moves to the system highest voltage level (VDD) and detecting result signal 415 moves from the low voltage level to the high voltage level again. Capacitor 551 is discharged by the current of current source 512 through NMOS transistor 532 and resistor 541 at the same time. The voltage at Node 5 has been the system lowest voltage level (ground), thus the output state of comparator 522 does not change.

When clock signal 418 is abnormal, detecting result signal 415 of clock state detecting device 407 also changes the voltage thereof. When clock state detecting device 407 detects that clock signal 418 is abnormal, the respondent time of changing state of detecting result signal 418 is determined by currents of current sources 511 and 514 and capacitors 551 and 552.

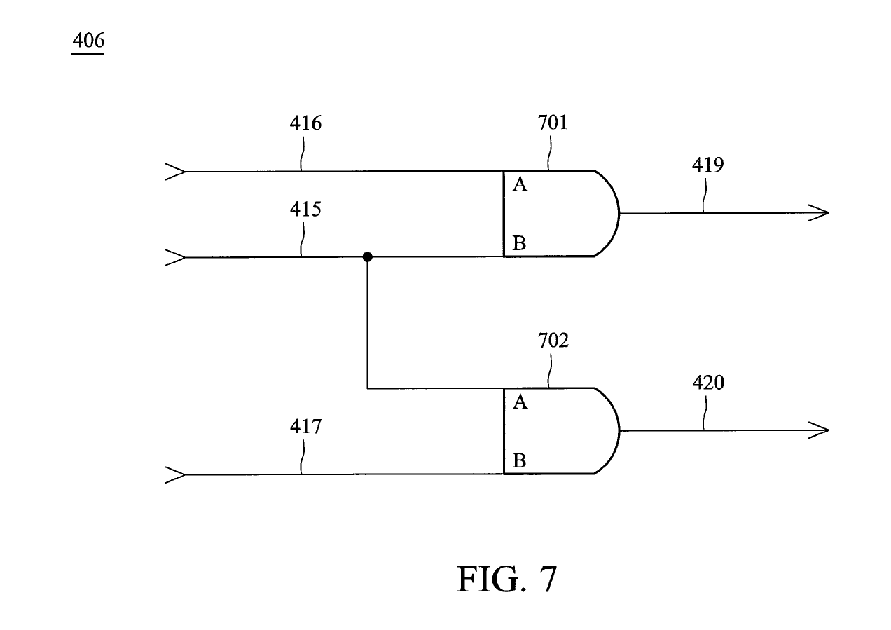

Please refer to FIG. 7, FIG. 7 shows detailed circuitry of output state control device 406 of an embodiment of the invention. Referring to FIG. 4 and FIG. 7 together, output state control device 406 comprises AND gates 701 and 702 as electronic switches. The A and B terminals of AND gate 701 receive first synchronous signal 416 and detecting result signal 415 respectively. The A and B terminals of AND gate 702 receive detecting result signal 415 and second synchronous signal 417 respectively. When clock signal 418 is normal, detecting result signal 415 is at logic high level; AND gates 701 and 702 receive first synchronous signal 416 and second synchronous signal 417 and output respectively horizontal synchronous signal 419 and vertical synchronous signal 420 to display monitor 441. On the contrary, when clock signal 418 is abnormal, AND gates 701 and 702 output horizontal synchronous signal 419 and vertical synchronous signal 420 at logic low level.

It is noted that detecting result signal 415 that clock state detecting device 407 outputs not only controls horizontal synchronous signal 419 and vertical synchronous signal 420, but also control D/A converters 403, 404 and 405 to output analog image signal 411, 412 and 413. It means that when clock signal 418 is abnormal, it is able to avoid display 441 to display abnormal images.

The invention provides an image processing method and an image processing device with a protecting display function. The invention also can be used in application of image decoders in the display and limit output of horizontal synchronous signal and vertical synchronous signal. Thus, input of horizontal synchronous signal and vertical synchronous signal of the display is controlled. The internal elements of the display, such as electron gun, are able to avoid to be used in an abnormal condition, and it enhances the lifetime of the display.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing method, comprising:
detecting a timing signal associated with an image signal for input to a display;
determining if the timing signal is abnormal; and
stopping the display to receive a synchronous signal associated with the image signal when the timing signal is abnormal.

2. The image processing method as claimed in claim 1, wherein the timing signal is a clock signal.

3. The image processing method as claimed in claim 2, wherein the timing signal is provided by an image source terminal.

4. The image processing method as claimed in claim 2, further comprising:
detecting a first condition in which the clock signal holds at high level for long time; and
detecting a second condition in which the clock signal holds at low level for long time.

5. The image processing method as claimed in claim 2, wherein determining the clock signal as abnormal when the clock signal holds at high level for long time or the clock signal holds at low level for long time is detected.

6. The image processing method as claimed in claim 1, wherein the timing signal is the synchronous signal or a clock signal generated after the synchronous signal is processed.

7. The image processing method as claimed in claim 1, wherein the synchronous signal includes a horizontal synchronous signal and a vertical synchronous signal and the display is stopped to receive the horizontal synchronous signal and the vertical synchronous signal when the timing signal is abnormal.

8. The image processing method as claimed in claim 1, further comprising stopping the display to receive not only the synchronous signal but also the image signal when the timing signal is abnormal.

9. The image processing method as claimed in claim 1, further comprising allowing the display to receive the synchronous signal when the timing signal is normal.

10. An image processing device, comprising:
a clock state detecting device, detecting a first clock signal to output a first detecting result signal based on the state of the first clock signal; and
an output state control device, receiving a first synchronous signal and a second synchronous signal to determine whether to output a horizontal synchronous signal and a vertical synchronous signal to the display based on the first detecting result signal.

11. The image processing device as claimed in claim 10, further comprising a digital signal processor, receiving and processing the digital image signal and outputting to the display.

12. The image processing device as claimed in claim 10, further comprising:
a digital signal processor, receiving and processing the digital image signal; and outputting the processed digital image signal to the display;
a D/A converter, receiving the digital image signal from the digital signal processor, and converting the digital image signal into an analog image signal for output to the display.

13. The image processing device as claimed in claim 10, further comprising:
a digital signal processor, receiving and processing the digital image signal and outputting the processed digital image signal to the display;
a D/A converter, receiving the digital image signal from the digital signal processor, and converting the digital image signal into an analog image signal for output to the display; and
a clock generator, receiving a second clock signal to generate the first clock signal, a third clock signal, the first synchronous signal and the second synchronous signal.

14. The image processing device as claimed in claim 10, wherein the clock state detecting device further includes:
a long time and high level clock detecting device, detecting if the first clock signal holds at high level for long time, outputting a second detecting result signal;
a long time and low level clock detecting device, detecting the clock signal, if the clock signal holds at low level for long time, outputting a third detecting result signal; and
a clock determining device, outputting the first detecting result signal according to the second detecting result signal and the third detecting result signal.

15. The image processing device as claimed in claim 14, wherein the long time and low level clock detecting device further comprises:
a first current source having a first terminal and a second terminal, the first terminal of the first current source coupled to a first voltage source;
a first electronic switch having a gate, a source and a drain, the source of the first electronic switch coupled to the second terminal of the first current source;
a second electronic switch having a gate, a source and a drain, the gate of the second electronic switch, the gate of the first electronic switch and the clock signal coupled to a first node, the drain of the second electronic switch and the drain of the first electronic switch coupled to a second node;
a second current source having a first terminal and a second terminal, the first terminal of the second current source coupled to the source of the second electronic switch, the second terminal of the second current source and a second voltage source coupled to a third node, wherein the current value of the second current source exceed the current value of the first current source;
a first resistor having a first terminal and a second terminal, the first terminal of the first resistor coupled to the second node;
a first capacitor having a first terminal and a second terminal, the first terminal of the first capacitor and the second terminal of the first resistor coupled to a fourth node, the second terminal of the first capacitor coupled to the third node; and
a first comparator having a first receiving terminal, a second receiving terminal, and an output terminal, the first receiving terminal of the first comparator coupled to a first reference voltage, the second receiving terminal of the first comparator coupled to the fourth node, the output terminal of the first comparator outputting the second detecting result signal.

16. The image processing device as claimed in claim 14, wherein the long time and high level clock detecting device further comprises:
a third current source having a first terminal and a second terminal, the first terminal of the third current source coupled to a first voltage source;
a third electronic switch, having a gate, a source and a drain, the source of the third electronic switch coupled to the second terminal of the third current source;
a fourth electronic switch having a gate, a source and a drain, the gate of the fourth electronic switch, the gate of the third electronic switch and the clock signal coupled to a fifth node, the drain of the fourth electronic switch and the drain of the third electronic switch coupled to a sixth node;
a fourth current source having a first terminal and a second terminal, the first terminal of the fourth current source coupled to the source of the fourth electronic switch, the second terminal of the fourth current source and a second voltage source coupled to a seventh node, a current of the fourth current source being less a current of the third current source;
a second resistor having a first terminal and a second terminal, the first terminal of the second resistor coupled to the sixth node;
a second capacitor having a first terminal and a second terminal, the first terminal of the second capacitor and the second terminal of the second resistor coupled to an eighth node, the second terminal of the second capacitor coupled to the eighth node; and
a second comparator having a first receiving terminal, a second receiving terminal, and a output terminal, the first receiving terminal of the second comparator coupled to a second reference voltage, the second receiving terminal of the second comparator coupled to the eighth node, the output terminal of the second comparator outputting the third detecting result signal.

17. The image processing device as claimed in claim 14, wherein the clock state determining device further comprises a fifth electronic switch having a first receiving terminal, a second receiving terminal, and an output terminal, the first receiving terminal and the second receiving terminal of the fifth electronic switch respectively receiving the second detecting result signal and the third detecting result signal to determine whether to output the first detecting result signal.

18. The image processing device as claimed in claim 15, wherein the first electronic switch is a PMOS transistor, the second electronic switch is a NMOS transistor and the second voltage source is ground.

19. The image processing device as claimed in claim 16, wherein the third electronic switch is a PMOS transistor, the fourth electronic switch is a NMOS transistor and the second voltage source is ground.

20. The image processing device as claimed in claim 17, wherein the fifth electronic switch is an NOR gate.

21. The image processing device as claimed in claim 10, wherein the clock state detecting device further comprises:
a delay having a first terminal and a second terminal, the first terminal of the delay coupled to a ninth node to receive the clock signal;
a sixth electronic switch having a first receiving terminal, a second receiving terminal and an output terminal, the first receiving terminal of the sixth electronic switch coupled to the ninth node, the second receiving terminal of the sixth electronic switch and the second terminal of the delay coupled to a tenth node;
a seventh electronic switch having a first receiving terminal, a second receiving terminal, and an output terminal, the first receiving terminal of the seventh electronic switch coupled to the tenth node, the second receiving terminal of the seventh electronic switch coupled to the ninth node;
a long time and low level clock detecting device detecting an first output signal from the output terminal of the sixth electronic switch, if the first output signal holds at low level for long time, outputting a second detecting result signal,
a long time and high level clock detecting device, detecting an second output signal from the output terminal of the seventh electronic switch, if the second output signal holds at high level for long time, outputting a third detecting result signal; and
a clock state determining device, determining to output the first detecting result signal according to the second detecting result signal and the third detecting result signal.

22. The image processing device as claimed in claim 21, wherein the sixth electronic switch is an OR gate and the seventh electronic switch is an AND gate.

23. The image processing device as claimed in claim 10, wherein the clock detecting device further comprises:
a delay having a first terminal and a second terminal, the first terminal of the delay coupled to a ninth node;
a sixth electronic switch having a first receiving terminal, a second receiving terminal and an output terminal, the first receiving terminal of the sixth electronic switch coupled to the ninth node, the second receiving terminal of the sixth electronic switch and the second terminal of the delay coupled to the tenth node;
a seventh electronic switch having a first receiving terminal, a second receiving terminal, and an output terminal, the first receiving terminal of the seventh electronic switch coupled to the tenth node, the second receiving terminal of the seventh electronic switch coupled to the ninth node;
an eighth electronic switch having a first receiving terminal, a second receiving terminal, and an output terminal, the first receiving terminal of the eighth electronic switch coupled to the clock signal, the output terminal of the eighth electronic switch coupled to the ninth node;
a power starter having an output terminal, the output terminal of the power starter and the second receiving terminal of the eighth electronic switch coupled to a eleventh node;
an inverter having an input terminal and an output terminal, the input terminal of the inverter coupled to the eleventh node;
a long time and low level clock detecting device having a first, a second, a third, a fourth and a fifth terminal, the first, the second and the third terminals coupled to the output terminal of the sixth electronic switch, a first voltage source and a second voltage source respectively, the fifth terminal of long time and high level clock detecting device outputting a second detecting result signal;
a long time and high level clock detecting device detecting the clock signal from the output terminal of the seventh electronic switch, having a first, a second, a third, a fourth and a fifth terminal, the first, the second and the third terminal coupled to the output terminal of the seventh electronic switch, the first voltage source and the second voltage source respectively, the fifth terminal of the long time and low level clock detecting device outputting a third detecting result signal;
a clock state determining device determining to output the first detecting result signal according to the second detecting result signal and the third detecting result signal;
a ninth electronic switch, having a gate a source and a drain, the gate, the source and the drain of the ninth electronic switch coupled to the output terminal of the inverter, the second voltage source, the fourth terminal of the long time and low level clock detecting device respectively; and
a tenth electronic switch, having a gate a source and a drain, the gate, the source and the drain of the tenth electronic switch coupled to the input terminal of the inverter, the first voltage source, the fourth terminal of the long time and high level clock detecting device respectively.

24. The image processing device as claimed in claim 23, wherein the sixth, the seventh, the eighth, the ninth and the tenth electronic switches respectively are an OR gate, a first AND gate, a second AND gate, a NMOS transistor and a PMOS transistor and the second voltage source is ground.

25. The image processing device as claimed in claim 23, wherein the outputting state control device further comprises:
an eleventh electronic switch having a first receiving terminal, a second receiving terminal, and an output terminal, the first receiving terminal and the second receiving terminal of the eleventh electronic switch coupled to the horizontal synchronous signal and the first detecting result signal respectively to determine whether to output the horizontal synchronous signal; and
a twelfth electronic switch having a first receiving terminal, a second receiving terminal, and an output terminal, the first receiving terminal and the second receiving terminal of the twelfth electronic switch coupled to the vertical synchronous signal and the first detecting result signal respectively to determine whether to output the vertical synchronous signal.

26. An image processing device, comprising:
a clock state detecting device, detecting a first clock signal and a second clock signal to output a first detecting result signal based on the state of the first clock signal and the second clock signal; and
an output state control device, receiving a first synchronous signal and the second synchronous signal to determine whether to output a horizontal synchronous signal and a vertical synchronous signal to the display based on the first detecting result signal.
